(19) United States
(12) Patent Application Publication
(10) Pub. No.: US 2006/0038025 A1
(43) Pub. Date: Feb. 23, 2006

(54) Wall thermostat kit to improve overall energy efficiency

(76) Inventor: Wilfred K. Lee, Santa Clara, CA (US)

Correspondence Address: US CORPORATIONS, INC., 630 NEPTUNE AVE., ENCINITAS, CA, 92024, US

(21) Appl. No.: 10/923,569

(22) Filed: Aug. 20, 2004

(51) Int. Cl. F24F 11/04; F28F 27/00; G05D 23/00

(52) U.S. Cl. 236/1 C; 236/51

(57) ABSTRACT

A wall thermostat kit to improve overall energy efficiency comprised of a programmable smart thermostat with a high-power, solid-state AC power switch capable of controlling an existing room air conditioner providing a simple & low cost solution for increasing overall energy efficiency as well as maintaining room temperature at a constant comfortable level.

### CROSS-REFERENCE TO RELATED APPLICATION:

Not applicable

### STATEMENT REGARDING FEDERALLY SPONSORED RESEARCH OR DEVELOPMENT:

Not applicable

### REFERENCE TO SEQUENCE LISTING:

Not applicable

### BACKGROUND OF THE INVENTION

This invention relates to a Wall Thermostat Kit capable of providing an economical means of performing cooling a small space economically, such as a bedroom or family room.

The current device consist of a wall thermostat kit (programmable Smart Thermostat with a high-power, solid-state AC Power Switch) to an existing room air conditioner (RAC) providing a simple & low cost solution for increasing overall energy efficiency of RAC as well as maintaining room temperature at a constant comfortable level.

Recent test results show an overall energy efficiency increase of 15 to 20 percent due to accurate temperature settings & an increase of 40 to 60 percent for the after-hour programmable timer settings with different temperature set-points. The installation of the device is simple. Installation is completed by connecting a pair of small low-voltage wires from the wall thermostat unit to the new AC power switch for the RAC. After completing the installation of the new device, you will see a definite improvement in the operational performance such as 1) automatically maintaining comfortable room temperature to within a two-degree variation and 2) a minimum of 20 percent increase in the energy efficiency usage of the RAC

It is common practice and standard in the industry to install a built in thermostatic device into most air conditioning units. This type of construction is ineffective in monitoring the temperature throughout the room. The built in thermostat only measures the temperature directly around the air conditioning unit, and usually only controls the air conditioner compressor, leaving the fan to continually run. Temperature variations can range within a room measuring only twelve feet by twelve feet by as much as 10 degrees.

The current device addresses the variation of temperatures and the power consumption issue. By simply attaching the current device to a room air conditioning unit, the room's temperature can be controlled more economically and efficiently.

The current device allows for easy installation to most Portable & Window Air Conditioning Units that operates on standard 110 volt AC outlet. Installation of 110 volt units can be easily performed by the homeowner or tenant without electrical experience. The installation for some of the higher voltage air conditioning units that operates at 220/240 volts, however, requires hiring a licensed electrician.

The system can be considered to contain only 3 components. A) The main unit is a small, battery operated smart thermostat, which will allow the user to select customizable times and temperatures. These settings will allow any user to choose what temperature they wish for the room to be and at what particular time. Like many existing smart thermostats, the existing device will allow the user to select times when it is not necessary for the room to be cooled allowing the unit to turn off. B). The unit will also contain an AC power switch, which will operate the existing room air conditioning unit. C.). The unit will also contain the appropriate wires and wiring diagram to connect the AC switch to the existing air conditioning unit. These three components are the major components of the current device.

### SUMMARY OF THE INVENTION

From the patent search performed and from our own searches on the USPTO website, we can find only one patent that closely approximates our product. It is the product described in U.S. Pat. No. 4,665,621. This is a very old (May 19, 1987) and very extensive patent, covering all aspects of the device and operation. Several aspects of this patent closely correspond to our product. I have attempted to list below the similarities and differences between the product described in the patent and ours.

In the following, the term “the product” refers to the electronic assembly described in U.S. Pat. No. 4,665,621.

The underlined statements are the similarities.
1) The product is self-contained. It does require an AC power cord while ours is battery operated.
2) The product is designed to be connected to a printer. The printer described is a full sheet printer, not a small label printer as in our unit. There appears to be no data storage capability in the product, meaning the printer must be continually attached, ours can be connected at the completion of the storage process.
3) The product uses a LCD display showing pocket location and depth stored. It does not incorporate auditory feedback from a speaker or LED indicators as prompts.
4) It product includes a 3 pedal footswitch. The footswitch has a totally different function than on our unit, and is not used to store data.
5) The product uses a storage pattern of tooth and pocket that closely approximates one of the storage pattern options on our unit. Our product has 2 additional storage modes. This pattern is the probably the most commonly used among dentists and dental hygienists as it a logical method to move quickly from tooth to tooth.
6) The most considerable difference between the product and ours is that it incorporates an electronic measuring probe to record the periodontal pocket depth. It may be considered a measuring and recording device. With our unit, the operator uses whatever manual-probing tool they like to measure the pocket depth, and only records the data with our device.

### BRIEF DESCRIPTION

The current device is primarily designed as an add-on device to an existing air conditioning unit. It is designed to aid in the energy efficiency of the air conditioning unit as well as the efficiency by which it cools the space it is associated with. We consider the end product to have three major components: A standard off-the-shelf smart thermostat, a proprietary design of a high-power AC Power Switch and our harness to attach the AC switch to the air conditioning unit.

Thus, it is an object of the invention to provide an improved wall thermostat kit for room air conditioners.

A further object of the invention is to provide a wall thermostat kit construction, which is rugged, economical, easily adjusted to selectable temperatures and to various combinations of tools and implements including but not limited to those discussed.

Another object of the invention is to provide an improved wall thermostat kit construction that embodies a proprietary design of a high-power, AC Power Switch and related supports designed to turn the existing wall air conditioner on and off as programmed in order to improve the AC efficiency and function.

Accordingly, it is an object of the present invention to provide a wall thermostat kit, which embodies an electronic wiring harness.

Further still, it is an object to provide such a wall thermostat kit, which will function with any portable or window room conditioner.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new wall thermostat kit apparatus and which has many of the advantages of the devices mentioned heretofore and many novel features that result in an wall thermostat kit which is not anticipated, rendered obvious, suggested, or even implied by any of the prior art tool guides, either alone or in any combination thereof.

It is another object of the present invention to provide a new wall thermostat kit, which may be easily and efficiently manufactured and marketed.

It is a further object of the present invention to provide a new wall thermostat kit, which is of a durable and reliable construction.

An even further object of the present invention is to provide a new wall thermostat kit which is susceptible of a low cost of manufacture with regard to both materials and labor, and which accordingly is then susceptible of low prices of sale to the consuming public, thereby making such wall thermostat kits economically available to the buying public.

Still yet another object of the present invention is to provide a new wall thermostat kit which provides in the apparatuses and methods of the prior art some of the advantages thereof, while simultaneously overcoming some of the disadvantages normally associated therewith.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

Illustrations

A perspective view of the present invention as viewed herein;

The Wall Thermostat Kit and its related parts are herein composed of:
1. Thermostat Kit
2. Air conditioner unit power switch

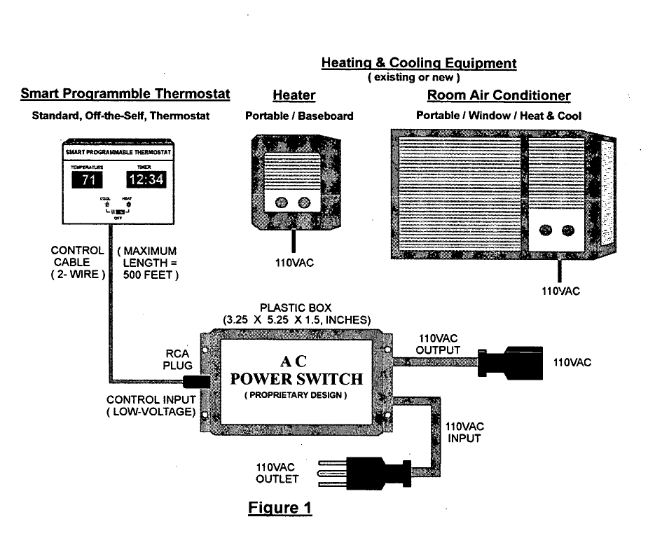

FIG. 1, wiring diagram of the Wall Thermostat Kit showing a simple wiring connection of the Smart Programmable Thermostat & a high-power AC Power Switch, for automatically controlling the AC power to Heating & Cooling equipment using power source from a 110V AC outlet.

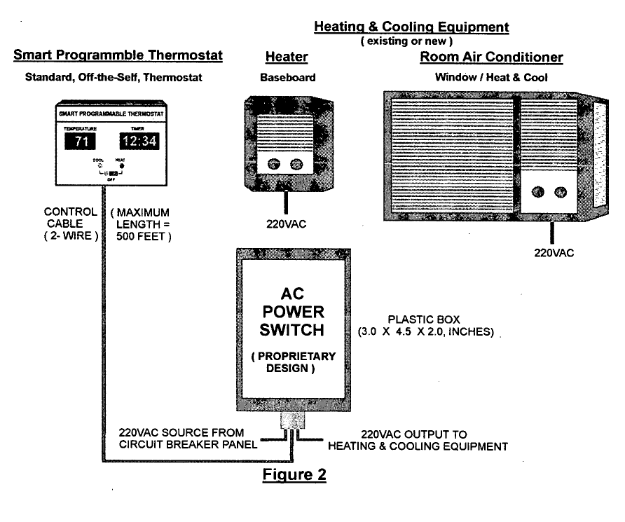

FIG. 2, a perspective wiring of the diagram of the Wall Thermostat Kit showing a simple wiring connection of the Smart Programmable Thermostat & a high-power AC Power Switch, for automatically controlling the AC power to Heating & Cooling equipment using power source from a 220V AC outlet.

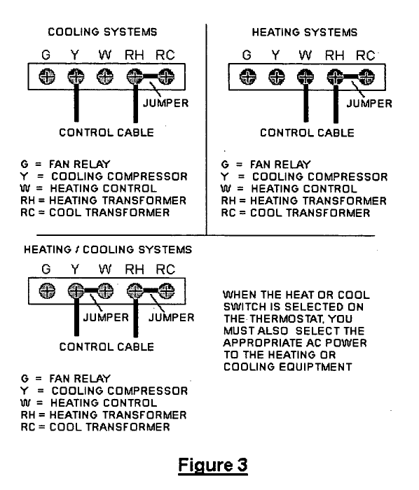

FIG. 3, Wiring diagram of Smart Programmable Thermostat showing typical connections for various types of Systems: Cooling, Heating & Heating/Cooling.

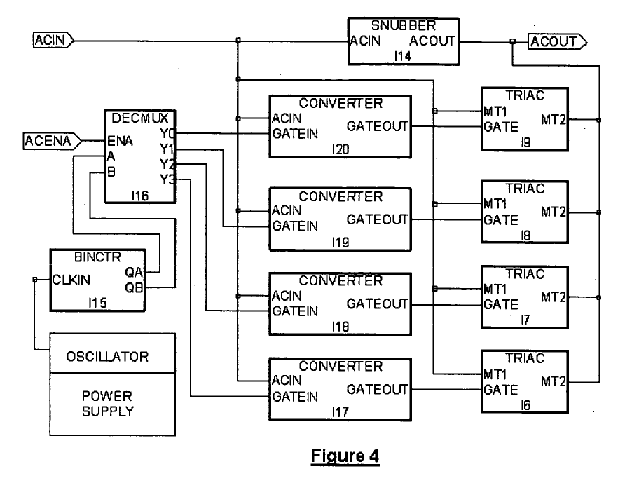

FIG. 4, Simplified detailed block diagram of high-power AC Power Switch (proprietary design to achieve higher power capacity)

Described as; now referring to FIG. 1, a Wall Thermostat Kit comprised of an input interface, FIG. 1 number 2, a air conditioner control switch which is connected to the portable room air conditioning unit, which is not a part of claims related to this application.

We claim:

1. A Wall Thermostat Kit comprised of an electronic, programmable thermostat, a proprietary design of a high power, AC Power Switch capable of interfacing an existing or new Room Air Conditioning Unit (Heat/Cool).

2. A Wall Thermostat Kit according to claim 1 wherein the device is battery operated and complete self-contained, does not require an AC plug or computer system, making it very portable.

3. A Wall Thermostat Kit according to claim 1 wherein the device controls the power to the portable room air conditioning unit.

4. A Wall Thermostat Kit according to claim 1 wherein information is entered and stored within the thermostat which includes, time, temperature and date

5. A Wall Thermostat Kit according to claim 1 wherein information stored within the thermostat unit controls the operating functions of the room air conditioning unit.
